(19) United States
(12) Patent Application Publication
(10) Pub. No.: US 2014/0000815 A1
(43) Pub. Date: Jan. 2, 2014

(54) Unknown

(71) Applicant: SOFINECO, Decines (FR)

(72) Inventors: Anne Sophie PANSERI, Montanay (FR); Romain SIMON, Caluire (FR); Armand POYET, Lyon (FR)

(21) Appl. No.: 13/930,310

(22) Filed: Jun. 28, 2013

Related U.S. Application Data
(60) Provisional application No. 61/665,381, filed on Jun. 28, 2012.

(51) Int. Cl. G05B 11/01; E06B 9/68; A47H 5/02

(52) U.S. Cl. CPC G05B 11/01; A47H 5/02; E06B 9/68
USPC 160/2; 160/310

(57) ABSTRACT

The contact-free detection device for detecting the position of a winding drum (2) for a handling door is made up of a cam or code wheel (3) secured to the winding drum (2), inductive sensors (4, 5) positioned near the cam or code wheel (3), and an electronic board (7) including at least one prevention and security module (12) receiving the pulses generated by the inductive sensors (4, 5) so as to ensure the security of the rotation command of the driving axis of the winding drum (2) of the handling door.

### FIELD OF THE INVENTION

The present invention relates to a device for the contact-free detection of the position and the direction of rotation of a winding drum for a handling door having a flexible curtain.

### SUMMARY OF THE INVENTION

The aim of the present invention is to design a method for detecting the position and the direction of rotation of a winding drum for a handling door and a detection device for carrying out the contact-free method, i.e., not using mechanical parts connecting to one another.

The present invention also relates to a detection device making it possible to carry out the contact-free detection method for detecting the position of a winding drum of a handling door.

The contact-free detection device for detecting the position of a winding drum for a handling door according to the present invention is made up of a cam or code wheel secured to said winding drum, inductive sensors positioned near said cam or code wheel, and an electronic board including at least one prevention and security module receiving the pulses generated by the inductive sensors so as to ensure the security of the rotation command of the driving axis of the winding drum of the handling door.

The contact-free detection device according to the present invention includes a prevention and security module that makes it possible to monitor the operation of the inductive sensors, the general electrical power supply, the energy level and the internal reserve of a storage module included by the electronic board; verify the direction of rotation and the speed of the winding drum as a function of information coming from the general control system of the handling door and the inductive sensors; cut the general control system of the handling door if a defect is observed; and keep the defect active as long as no restart has been performed.

The contact-free detection device according to the present invention includes a prevention and security module comprising control relays or any equivalent electronic system making it possible to monitor and control at least one braking and fall arrest system of the handling door.

The contact-free detection device according to the present invention includes a prevention and security module comprising control relays or any equivalent electronic system making it possible to monitor the distance due to the response time of the braking command and the mechanical response time of the braking system and to completely block the general control system of handling door.

The contact-free detection device according to the present invention includes a prevention and security module comprising control relays or any equivalent electronic system making it possible to monitor detection and security members provided to detect a barricade or obstacle preventing the movements of the handling door.

The contact-free detection device according to the present invention includes a prevention and security module comprising control relays or any equivalent electronic system making it possible to monitor, after detection by the security members, the distance traveled by a flexible curtain secured to the winding drum of the handling door.

The contact-free detection device according to the present invention includes an electronic board comprising a module for receiving and processing pulses generated by the inductive sensors so as to determine the direction of rotation of the cam or code wheel secured to the winding drum.

The contact-free detection device according to the present invention includes an electronic board comprising a counting module that is connected to the receiving module by two circuits so as to count the pulses generated by the inductive sensors so as to increment or decrement its memory as a function of the direction of rotation of the cam or code wheel secured to the winding drum.

The contact-free detection device according to the present invention includes an electronic board comprising a signal conversion module that is connected to the counting module so as to convert the binary word stored in the memory of said counting module into an analog signal making it possible to control the control members of the handling door.

The contact-free detection device according to the present invention includes an electronic board comprising a storage module that is connected to the receiving and counting modules and inductive sensors making it possible to conserve energy to keep said modules and sensors in standby mode.

The contact-free detection device according to the present invention includes an electronic board comprising an energy conversion module that is connected to the signal conversion and storage modules making it possible to convert the energy into voltage to power the various modules of the detection device.

The contact-free detection device according to the present invention includes a cam or code wheel comprising recesses and notches or inductives that pass in front of the inductive sensors upon each movement of the winding drum.

### BRIEF DESCRIPTION OF THE DRAWINGS

The following description in light of the appended drawings, provided as non-limiting examples, will make it possible to better understand the invention, the features thereof, and the advantages it may procure:

### DETAILED DESCRIPTION OF THE INVENTION

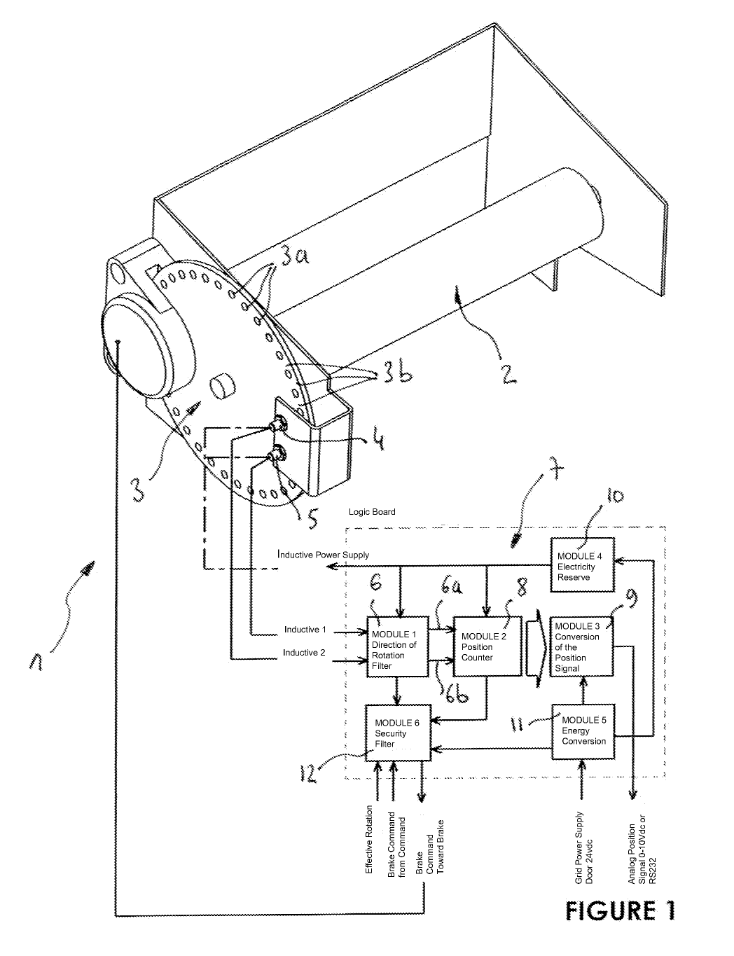

FIG. 1 is a diagrammatic view illustrating the detection device making it possible to carry out the contact-free detection method for detecting the position of a winding drum of a handling door according to the present invention.

FIG. 1 shows a detection device 1 for carrying out a contact-free detection method making it possible to determine the position and the direction of rotation of a winding drum 2 of a handling door.

The detection device 1 is made up of a cam or code wheel 3 mounted at one of the ends of the winding drum 2 secured to a flexible curtain of the handling door.

The cam or code wheel 3 includes recesses, bores or housings 3a and notches, bosses, raised portions or inductives 3b positioned at regular intervals, the lay ratio between said intervals being constant. The lay ratio between the position of the recesses 3a and the notches or inductives 3b of the cam or wheel 3 must be comprised between 1 and 2.

According to one preferred embodiment of the invention, the lay ratio between the position of the recesses 3a and the notches or inductives 3b of the cam or wheel 3 is 1.5.

The detection device 1 includes inductive sensors 4, 5 respectively positioned near the cam or code wheel 3. The latter makes it possible, when it is rotated by the winding drum 2 of the handling door, to control the inductive sensors 4, 5.

This rotation allows the cam or code wheel 3 to cause the inductive sensors 4, 5 to alternate between the on condition and the off condition in order to generate a pulse train.

It will be noted that the on condition corresponds to the passage of the notches or inductives 3b in front of the inductive sensors 4, 5, while the off condition corresponds to the passage of the recesses 3a in front of said inductive sensors 4, 5.

Said inductive sensors 4, 5 are connected to a receiving module 6 included by an electronic board 7.

The electronic board 7 of the detection device 1 includes at least one prevention and security module 12 receiving the pulses generated by the inductive sensors 4, 5 so as to ensure the security of the rotation command of the drive axis of the winding drum 2 of the handling door.

The electronic board 7 of the detection device 1 also includes counting 8, signal conversion 9, storage 10, and energy conversion 11 modules, connected to each other.

The receiving and processing module 6 receives the pulses generated by the inductive sensors 4 and 5 so as to determine the direction of rotation of the cam or code wheel 3 secured to the winding drum 2 with respect to the logical secure direction of rotation of the handling door. As a function of the direction of rotation, the receiving and processing module 6 returns said pulses either on a circuit 6a or on a circuit 6b toward the counting module 8.

The counting module 8 makes it possible to count the pulses generated by the inductive sensors 4 and 5 so as to increment or decrement its position memory as a function of the direction of rotation of the cam or code wheel 3 secured to the winding drum 2.

As a function of the condition of its memory, the counting module 8 sends a binary word to the signal conversion module 9.

The detection device 1 comprises a signal conversion module 9 that is responsible for converting the binary position word stored in the memory of the counting module 8 into a communication language, for example such as an analog signal. The signal conversion module 9 then conveys that signal toward control members of the handling door.

The detection device 1 comprises a storage module 10 connected to the receiving 6 and counting 8 modules and to the inductive sensors 4 and 5. The storage module 10 makes it possible to conserve energy to keep said modules and said sensors in standby mode.

The detection device 1 comprises an energy conversion module 11 connected to the signal conversion 9 and storage 10 modules. The energy conversion module 11 makes it possible to convert the energy into voltage to power the different modules of the detection device 1 and more particularly the receiving 6 and counting 8 modules as well as the inductive sensors 4 and 5.

The detection device 1 comprises a prevention and security module 12 including control relays or any equivalent electronic system connected to the receiving 6, counting 8 and energy conversion 11 modules.

The prevention and security module 12 makes it possible to monitor the operation of the inductive sensors 4 and 5, the electrical power supply, the energy level and the internal reserve of the storage module 10.

In fact, the shape of the cam or code wheel 3 requires that the inductive pulses alternate between being that of the first sensor 4 and that the second sensor 5. In the case where one of the two sensors 4, 5 sends two pulses without the other sensor having sent any, then one of the two sensors 4 and 5 is considered to be defective.

Under these conditions, the prevention and security module 12 blocks the control system of the handling door.

The prevention and security module 12 makes it possible to verify the direction of rotation and the speed of the winding drum 2 based on information from the general control system of the handling door and the inductive sensors 4, 5.

In fact, the prevention and security module 12 receives information from the general control system of the handling door indicating the movement command as well as the requested direction, i.e., raised or lowered, of the flexible curtain of the handling door.

From this information as well as information from the inductive sensors 4, 5 and the receiving module 6, the prevention and security module 12 verifies the direction of rotation and the speed of the winding drum 2 of the handling door. If the prevention and security module 12 observes an operating nonconformity, it blocks the control system of the handling door.

The prevention and security module 12 makes it possible to block the general control system of the handling door if a defect is observed, and to keep the defect active as long as no restart has been done. There are two levels of blocking the general control system of the handling door.

The first blocking level consists of cutting the current, in which case the system restarts after the power supply reappears.

The second blocking level includes all of the other defects observed by the prevention and security module 12, in which the system may only be restarted using a mechanical or electronic key.

In the case where the handling door includes braking and fall arrest systems, and/or detection and security members monitoring the distance traveled by the flexible curtain or barriers before lowering the curtain, the prevention and security module 12 may monitor each of its devices and block the general control system of the handling door when necessary.

Furthermore, the prevention and security module 12 makes it possible to monitor the distance due to the response time of the braking command and the mechanical response time of the braking system to completely block the general control system of the handling door.

The prevention and security module 12 makes it possible to monitor, after detection by the security members, the distance traveled by the flexible curtain secured to the winding drum 2 of the handling door.

According to one particular operating mode, the detection device 1 allows the contact-free detection of the position of the winding drum 2 of a handling door by:
Sensing a pulse train generated by the inductive sensors 4, 5 commanded by the cam or wheel 3 arranged on the drive axis of the winding drum 2 of the door,
Determining the direction of rotation of the cam or wheel 3,
Counting the number of pulses generated by the inductive sensors 4, 5,
Converting the pulses generated by the inductive sensors 4, 5 into a signal making it possible to control the control members of the handling door.

It must also be understood that the preceding description has been provided solely as an example and in no way limits the field of the invention; it would not be beyond the scope of the invention to replace the described details of embodiments with any equivalents.

1. A contact-free detection device for detecting the position of a winding drum (2) for a handling door, characterized in that it is made up of a cam or code wheel (3) secured to said winding drum (2), inductive sensors (4, 5) positioned near said cam or code wheel (3), and an electronic board (7) including at least one prevention and security module (12) receiving the pulses generated by the inductive sensors (4, 5) so as to ensure the security of the rotation command of the driving axis of the winding drum (2) of the handling door.

2. The detection device according to claim 1, characterized in that the prevention and security module (12) makes it possible to monitor the operation of the inductive sensors (4, 5), the general electrical power supply, the energy level and the internal reserve of a storage module (10) included by the electronic board (7); verify the direction of rotation and the speed of the winding drum (2) as a function of information coming from the general control system of the handling door and the inductive sensors (4, 5); cut the general control system of the handling door if a defect is observed; and keep the defect active as long as no restart has been performed.

3. The detection device according to claim 1, characterized in that the prevention and security module (12) comprises control relays or any equivalent electronic system making it possible to monitor and control at least one braking and fall arrest system of the handling door.

4. The detection device according to claim 1, characterized in that the prevention and security module (12) includes control relays or any equivalent electronic system making it possible to monitor the distance due to the response time of the braking command and the mechanical response time of the braking system and to completely block the general control system of handling door.

5. The detection device according to claim 1, characterized in that the prevention and security module (12) includes control relays or any equivalent electronic system making it possible to monitor detection and security members provided to detect a barricade or obstacle preventing the movements of the handling door.

6. The detection device according to claim 1, characterized in that the prevention and security module (12) includes control relays or any equivalent electronic system making it possible to monitor, after detection by the security members, the distance traveled by a flexible curtain secured to the winding drum (2) of the handling door.

7. The detection device according to claim 1, characterized in that the electronic board (7) comprises a module for receiving and processing pulses generated by the inductive sensors (4, 5) so as to determine the direction of rotation of the cam or code wheel (3) secured to the winding drum (2) with respect to the logical secure direction of rotation of the handling door.

8. The detection device according to claim 7, characterized in that the electronic board (7) comprises a counting module (8) that is connected to the receiving module (6) by two circuits (6a, 6b) so as to count the pulses generated by the inductive sensors (4, 5) so as to increment or decrement its memory as a function of the direction of rotation of the cam or code wheel (3) secured to the winding drum.

9. The detection device according to claim 8, characterized in that the electronic board (7) comprises a signal conversion module (9) that is connected to the counting module (8) so as to convert the binary word stored in the memory of said counting module (8) into an analog signal making it possible to control the control members of the handling door.

10. The detection device according to claim 8, characterized in that the electronic board (7) comprises a storage module (10) that is connected to the receiving and processing (6) and counting (8) modules and inductive sensors (4, 5) making it possible to conserve energy to keep said modules and sensors in standby mode.

11. The detection device according to claim 2, characterized in that the electronic board (7) comprises a signal conversion module (9) that is connected to the counting module (8) so as to convert the binary word stored in the memory of said counting module (8) into an analog signal making it possible to control the control members of the handling door, the electronic board further comprising an energy conversion module (11) that is connected to the signal conversion (9) and storage (10) modules making it possible to convert the energy into voltage to power the various modules of the detection device (1).

12. The detection device according to claim 1, characterized in that the cam or code wheel (3) includes recesses (3a) and notches or inductives (3b) that pass in front of the inductive sensors (4, 5) upon each movement of the winding drum (2).
